(19) United States
(12) Patent Application Publication
(10) Pub. No.: US 2011/0193268 A1
(43) Pub. Date: Aug. 11, 2011

(54) PROCESSING METHOD

(75) Inventor: Satoshi Kokubo, Kawasaki-shi (JP)

(73) Assignee: CANON KABUSHIKI KAISHA, Tokyo (JP)

(21) Appl. No.: 13/056,647

(22) PCT Filed: Jul. 28, 2009
(86) PCT No.: PCT/JP2009/063713

§ 371 Date: Jan. 28, 2011

(30) Foreign Application Priority Data
Aug. 1, 2008 (JP) 2008-199489
Jun. 23, 2009 (JP) 2009-149063

(51) Int. Cl. B29C 35/08

(52) U.S. Cl. 264/400

(57) ABSTRACT

In a processing method using laser light, light energy is effectively used and a time necessary for processing is shortened. The processing method includes a basic shape formation step of forming a recess pattern smaller in depth than a recess shape on a surface of a workpiece; and a shape growth step of irradiating the recess pattern with laser light which has a fluence such that the etching rate at a recess bottom surface of the recess pattern is larger than the etching rate on the workpiece surface and has a beam diameter larger than a width of the recess pattern so as to process the recess shape.

### TECHNICAL FIELD

The present invention relates to microprocessing by laser processing, and, more particularly, relates to a processing method which processes a fine recess shape by using an ultrashort pulse laser.

### BACKGROUND ART

It is known that general laser processing utilizes the effect by thermogenesis due to light absorption; however, in the case of using an ultrashort pulse laser, non-thermal processing is possible. Consequently, high quality processing can be performed without causing shape collapse or the like due to heat.

However, in the case of performing microscopic and high quality processing by ultrashort pulse laser light, the irradiation energy is required to set to energy near to a processing threshold. In the case of giving large irradiation energy, an increase in processing dimension and damage of a peripheral portion of a machining region are incurred (see Masaki Hashida, Kengo Nagashima, Masayuki Fujita, Masahiro Tsukamoto, Masahito Kattou, and Yasukazu Izawa, “Femtosecond Laser Ablation of Metals—Features of New Processing Phenomena and Nanostructure Formation—,” 9th Symposium on “Microjoining and Assembly Technology in Electronics,” 2003, pp. 517 to 522). Therefore, there is an unsolved problem in that energy output from a laser source cannot be sufficiently and effectively used.

In Japanese Patent Application Laid-Open No. 2001-138083, there is disclosed a method in which a pulse is divided and passed through a delay circuit to make a plurality of pulse trains and energy per one pulse is lowered, thereby preventing a peripheral portion from being damaged, and achieving an effective use of energy. In addition, in Japanese Patent Application Laid-Open No. H05-57464, it has been proposed that laser light is divided by a diffraction optical element and a plurality of positions are processed at the same time.

However, in the technology disclosed in Japanese Patent Application Laid-Open No. H05-57464, when the intensity of laser light is tried to be subjected to uniform time division, restriction is incurred in the number of division. In addition, in the case of time division by a partial reflection mirror, a number of pulses can be obtained; however, the intensity is gradually attenuated with a change in intensity. Actually, a pulse effective for processing is very limitative, and this method cannot sufficiently utilize the energy of a laser source.

Furthermore, in the technology which spatially divides a beam disclosed in Japanese Patent Application Laid-Open No. 2001-138083, several tens to several hundreds of processing spots are obtained at the same time; and therefore, it is effective for improvement in processing efficiency. However, a diffraction phase grating for diverging of a beam needs to be made for each shape, and a loss of light energy is produced by the diffraction phase grating.

In view of the foregoing, an object of the present invention is to provide a processing method in which, in microprocessing, light energy from a laser source is effectively used by a simple means, and a time necessary for processing can be shortened.

### DISCLOSURE OF THE INVENTION

In order to solve the aforementioned problem and to attain the aforementioned object, according to the present invention, there is provided a processing method of processing a recess shape on a surface of a workpiece, which includes:

a basic shape formation step of forming a recess pattern smaller in depth than the recess shape on the surface of the workpiece; and

a shape growth step of irradiating the recess pattern with laser light which has a fluence such that the etching rate at a recess bottom surface of the recess pattern is larger than the etching rate on the workpiece surface and has a beam diameter larger than a width of the recess pattern so as to process the recess shape.

Light intensity distribution corresponding to a processing shape does not need to be formed. Therefore, complicated optical system and apparatus are not necessary and it becomes possible to suppress light loss to be small. In an upper limit of light energy of a laser source, the processing area can be widely obtained as much as possible; and therefore, the utilization efficiency of light energy can be maximized and the processing speed can be increased.

Because processing is performed by using an ultrashort pulse laser whose thermal influence is minimal, a shape with high accuracy can be obtained.

Further features of the present invention will become apparent from the following description of exemplary embodiments with reference to the attached drawings.

### BRIEF DESCRIPTION OF THE DRAWINGS

FIGS. 1A and 1B are views for illustrating an embodiment;

FIGS. 2A and 2B are graphical representations showing result of measurement of a section of a workpiece in Example 1;

FIG. 3 is a view illustrating a configuration of an apparatus used in Example 2; and

FIGS. 4A and 4B are sectional observation images showing a workpiece according to Example 2.

### BEST MODE FOR CARRYING OUT THE INVENTION

One embodiment for embodying the present invention will be described with reference to the accompanying drawings.

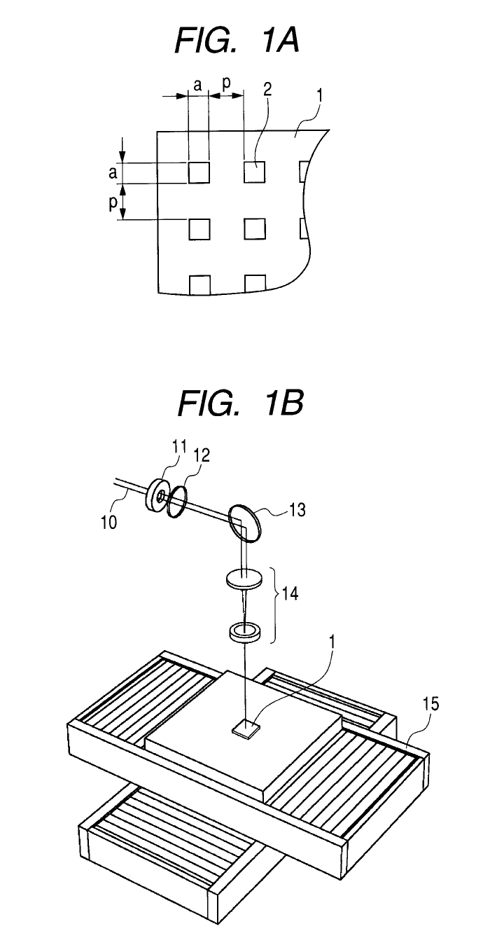

FIGS. 1A and 1B are views for illustrating one embodiment; FIG. 1A shows a recess shape pattern; and FIG. 1B shows a laser processing apparatus.

### (Basic Shape Formation Step)

First, as shown in FIG. 1A, for example, a recess pattern 2 which has a small difference in height in which the length of one side is a and the depth is smaller than a depth of a desirable recess shape (the distance from a workpiece surface to a recess bottom portion is small) is formed on a surface of a workpiece 1 in a grid pattern at an interval p. In the present embodiment, a square recess pattern is disposed in a grid-like pattern; however, it may be circular, elliptical, linear, or rectangular instead of a square shape. Hereinafter, such a step which forms a recess pattern is referred to as a basic shape formation step. The processing method of the recess pattern is not particularly limited. For example, an optimal processing method such as laser processing, ion beam processing, electron beam processing, photolithography may be selected from the stand point of dimension and shape accuracy of a desirable pattern shape, material of the workpiece, cost, and the like. For example, in the case of selecting laser processing, it is possible to use a laser source to be used in the subsequent step and it becomes possible to perform processing by one apparatus.

The workpiece 1 is processed by a selected processing method to form the recess pattern 2. It is preferable to process so that the depth of the pattern 2 is equal to or more than 0.05 time the length (width) a of one side of the square-shaped pattern 2. In the case where the pattern shape is not square or circular, for example, in the case of being elliptical, linear, or rectangular, the length in the widthwise direction of the shape is defined as width a.

### (Shape Growth Process)

The recess pattern 2 formed on the surface of the workpiece 1 is irradiated with laser light. For example, a laser processing apparatus as shown in FIG. 1B is used. In FIG. 1B, after a laser beam 10 from a laser source (not shown) is passed through a shutter 11, the laser beam is made to be appropriately attenuated by a neutral density (ND) filter 12; and then, the laser beam is introduced to a beam shaper 14 via a mirror 13. The beam shaper 14 is a refracting beam shaping unit and also has a function of adjusting the beam diameter. Incidentally, a refracting beam shaping unit can use a method described in, for example, a document by F. M. Dickey et al., “Laser Beam Shaping” Marcel Dekker, Inc., pp. 168 to 174 (2000).” By using such a laser processing apparatus, the recess pattern is irradiated with laser light, which has a fluence such that the etching rate at a recess bottom surface of the recess pattern is larger than the etching rate on the workpiece surface and has a beam diameter larger than the width of the recess pattern. With this method, it becomes possible to increase a vertical difference (difference in height) between the recess bottom surface and the workpiece surface. It is conceivable that the reason is as follows:

When a workpiece having a recess portion is irradiated with a laser, waveguide action to a depth direction can be obtained by multiple reflections between side walls of the recess portion. Due to this, a difference in etching rate between a protruding portion as a surface of the workpiece and a recessed portion is generated. This action is utilized and laser light which does not have light intensity distribution, but has substantially uniform light intensity distribution is merely irradiated to the workpiece surface, so that the depth of the previously formed recess pattern is increased and a recess shape with a desirable difference in height can be formed. Hereinafter, this processing step is referred to as shape growth step.

In this method, the irradiation intensity pattern of the laser light does not depend on the pattern shape to be processed; and therefore, an irradiation region can be easily enlarged. Consequently, it takes full advantage of light energy from a laser source, whereby a wide region can be processed collectively.

Furthermore, a complicate light intensity pattern does not need to be formed; and therefore, the shape growth step can be performed with a simple optical system. Moreover, the shape growth step can be performed with the simple optical system; and accordingly, it becomes possible to adopt an optical system having low loss of light energy. In the shape growth step, pulse laser light whose pulse duration is equal to or more than 10 femtoseconds and less than 1 nanosecond may be used as a light source.

When the pulse duration is set to be less than 1 nanosecond in the pulse laser light, processing by non-thermal action can be obtained. An ultrashort pulse laser less than 1 nanosecond in the pulse duration is utilized as a light source in the shape growth step, whereby it becomes possible to perform microscopic shape formation having no shape blunt due to thermofusion. Specifically, the shape growth step can be applied to a shape having a processing resolution of several tens nm to several μm. In the case of being less than 10 femtoseconds, the processing can be hardly performed.

In addition, the fluence of the laser light in the shape growth step may be set to equal to or more than 1 time and equal to or less than 40 times as high as a processing threshold of the workpiece. The fluence can be changed by attenuation by the ND filter and the beam diameter so as to be the fluence such that the etching rate at the recess bottom surface of the recess pattern is larger than the etching rate at the workpiece surface.

The difference in etching rate by the laser light between the protruding portion (workpiece surface) and the recessed portion (recess shaped bottom surface) appears most effectively when the irradiation fluence of the laser light is equal to or more than 1 time and equal to or less than 40 times as high as the processing threshold. In the case where the shape growth step is performed with an irradiation fluence which largely exceeds this range, there may be a case where the difference in height between the protruding portion (workpiece surface) and the recess bottom surface of a pattern formed by the basic shape formation step is reduced.

The term “processing threshold” herein employed refers to a value of the fluence at which a workpiece starts to be etched by irradiation of laser light.

It is known that a plurality of thresholds are present in laser beam processing and, more particularly, when metal is processed by an ultrashort pulse laser, three thresholds are present (see Masaki Hashida, Kengo Nagashima, Masayuki Fujita, Masahiro Tsukamoto, Masahito Kattou, and Yasukazu Izawa, “Femtosecond Laser Ablation of Metals—Features of New Processing Phenomena and Nanostructure Formation—,” 9th Symposium on “Microjoining and Assembly Technology in Electronics,” 2003, pp. 517 to 522). It is known that the plurality of thresholds indicate values of the fluence at which the etching rate changes; the smallest threshold is based on a multiphoton absorption process of metal, the second one is based on photodissociation, and the largest threshold is based on a thermal process. What is referred to as the processing threshold in the present invention corresponds to the smallest threshold (based on the multiphoton absorption process of metal). In addition, in the case of exceeding the largest threshold and when the thermal process becomes dominant, a difference in etching rate with the laser light between the protruding portion as the workpiece surface and the recessed portion is gradually reduced. The value of this threshold varies depending on the material; however, the range in which the difference in etching rate can be obtained is within approximately 40 times with respect to the processing threshold. Furthermore, in nonmetal material, the range in which the difference in etching rate can be obtained is within approximately 40 times with respect to the processing threshold.

It is preferable that the width in the widthwise direction of the recess portion to be processed is equal to or more than 0.2 μm and less than 10 μm.

When the width of facing side walls of the recess portion is less than 10 μm, the waveguide action can be most effectively obtained. Therefore, when the width in the widthwise direction of the recess portion to be processed is set to be less than 10 μm, the shape growth can be performed most effectively. In the case of being less than 0.2 μm, it is difficult to perform processing.

In the shape growth step, as shown in FIG. 1B, laser light output from a laser source is shaped to a laser beam 10 having a necessary beam diameter via a beam expander, a condenser lens, or the like. This laser beam 10 is appropriately uniformized in beam intensity distribution by a beam shaper 14 to serve as laser light having uniform light intensity distribution. The surface of the workpiece 1 on a stage 15 is irradiated with the laser light; the depth of a pattern 2 shown in FIG. 1B is made to increase; and a recess shape having a desirable difference in height is formed.

It is conceivable that the beam shaping unit has various configurations. For example, the beam shaping apparatus may be configured so as to allow only a center portion of a laser beam to pass therethrough by using a circular aperture. Alternatively, various beam shaping apparatuses, such as an optical filter (for example, GC-25 (trade name); manufactured by OFR Inc., USA) having spatial transmittance distribution in which beam intensity distribution is inverted, a method of using an integration lens, one which uses a refracting optical system, one which uses a diffraction optical element, and the like are conceivable. In addition, a device in which a beam expander is integrated with a beam shaping unit is conceivable. The uniformity of light intensity distribution may be determined by processing depth uniformity or the like; and selection is made as to whether or not the beam shaping unit is used depending on the uniformity and system selection of the beam shaping unit is performed. It is preferable to select a system having low loss from the viewpoint of the utilization efficiency of light energy of the laser source.

In addition, it is also possible to replace the beam shaping unit by a method in which a laser beam is allowed to relatively scan on the workpiece to uniformize accumulated light energy irradiated per unit area.

The beam diameter and the beam shaping unit are designed such that the irradiation fluence of laser light at the workpiece surface becomes optimal. As needed, an attenuation unit of light energy such as an ND filter may be further added. It is desirable that the irradiation fluence is within a range from 1 time to 40 times as high as the processing threshold.

A workpiece surface is irradiated with the thus adjusted laser beam for a necessary period of time to increase the depth of the recess shaped pattern formed in the basic shape formation step up to the desirable difference in height. It is preferable that the period of time necessary for irradiation is equal to or more than 1 millisecond and equal to or less than 1 min. In the case of being less than 1 millisecond, it is hardly processed; and, in the case of being more than 1 min, it is apt to cause shape collapse.

### EXAMPLE

Hereinafter, the present invention will be specifically described by examples. In this case, however, the present invention is not limited to such examples.

### Example 1

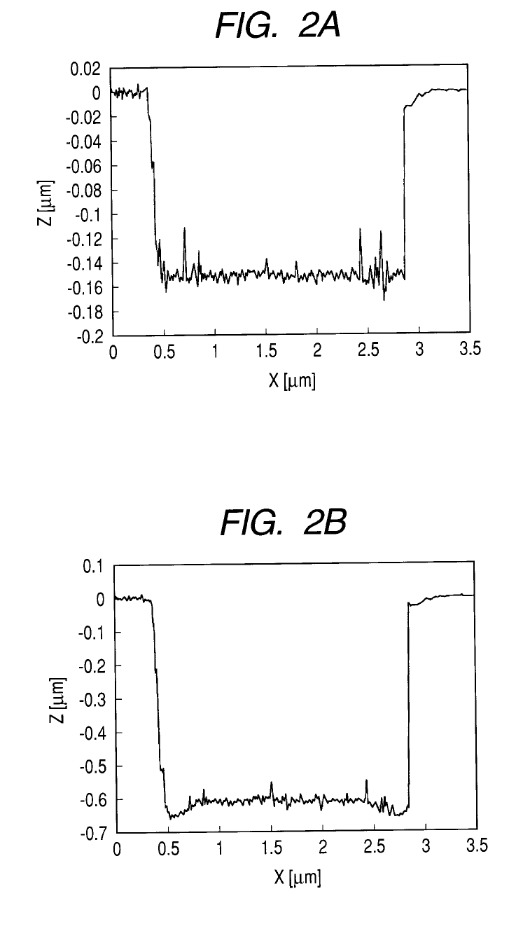

The processing method described in the above embodiment will be specifically described. As a basic shape formation step, a focused ion beam processing observation apparatus (hereinafter, referred to as FIB apparatus) was used to form a recess shaped pattern 2 shown in FIG. 1A on a workpiece 1. The workpiece 1 was a copper plate; and the recess shaped pattern 2 which was a square having one side length a of 2.5 μm and was smaller in difference in height than a desirable uneven shape was formed on the copper plate in a grid-like pattern at an interval p of 4.2 μm. In this step, the workpiece 1 was placed on a work stage of the FIB apparatus; a gallium ion beam was accelerated at an accelerating voltage of 40 kV; and a beam focused by an electron lens was applied to a workpiece surface via an aperture of 150 μm diameter. In this way, ablation processing of the workpiece surface was performed, and the processing was performed so that the depth of the pattern 2 became 0.15 μm. A cross-sectional shape measurement result by an atomic force microscope at this time is shown in FIG. 2A.

A shape growth step was performed to the workpiece 1 in which the pattern 2 was formed by the basic shape formation step by the following procedure. FIG. 1B shows a configuration of an apparatus used in a shape growth step. A laser beam 10 from a laser source (not shown) was allowed to pass through a shutter 11 and then appropriately attenuated by an ND filter 12. After that, the laser beam 10 was introduced to a beam shaper 14 via a mirror 13. The beam shaper 14 is a refracting beam shaping unit and also has a function of adjusting a beam diameter. Incidentally, a refracting beam shaping unit is described in, for example, F. M. Dickey et al., “Laser Beam Shaping” Marcel Dekker, Inc., pp 168 to 174 (2000).”

The laser source used was a titanium sapphire regenerative amplifier having a wavelength of 800 nm, a pulse width of 130 fs, and a repeating frequency of 1 kHz. A laser light of 1.2 mJ and a diameter of 8 mm was emitted from the oscillation source. The beam shaper 14 also has a conversion function for the beam diameter having a reduction ratio of 10.5:1 and the laser was emitted as a beam having a diameter of 0.76 mm. The ND filter 12 was selected so that the pulse energy after emission of the beam shaper 14 became 0.91 mJ. By doing so, a laser beam having uniform light intensity distribution of an irradiation fluence of 0.20 J/cm² was obtained. This value corresponded to approximately 11 times the processing threshold of copper.

The workpiece 1 placed on the stage 15 was irradiated with a laser beam which had uniform light intensity distribution for 100 milliseconds to perform the shape growth step.

When the workpiece surface obtained by the shape growth step was measured by an atomic force microscope, the basic shape having the width of the pattern recess portion of 2.5 μm was not changed; but, it was confirmed that an average depth (difference in height) of the pattern bottom portion was grown to 0.61 μm. The measurement result is shown in FIG. 2B.

According to the present example, a difference in height can be made to grow by a simple manner while maintaining a microscopic pattern shape obtained by the basic shape formation step. The shape growth step can be realized by an optical system with a small optical loss; and besides, a wide region is processed at a time, whereby the utilization efficiency of light energy can be dramatically increased. Furthermore, a wide region can be processed in a very short period of time; and therefore, it becomes possible to shorten the time necessary for processing.

### Example 2

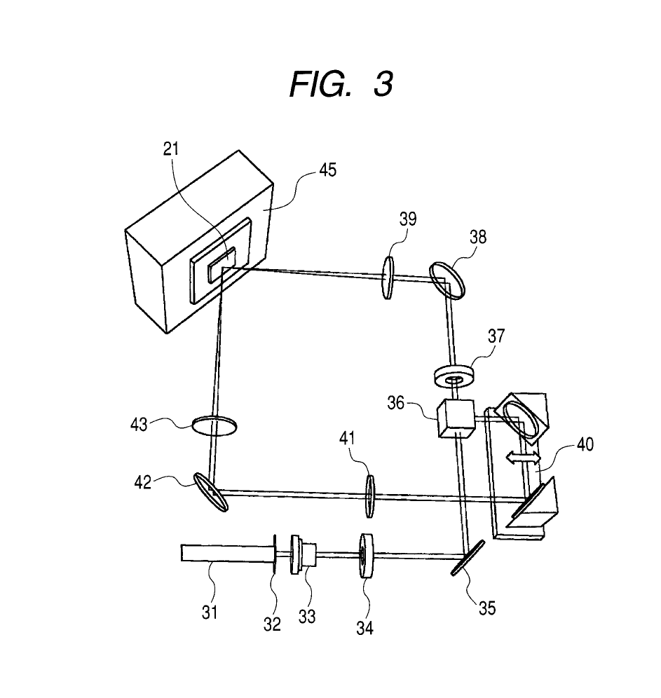

FIG. 3 shows a processing apparatus used in a basic shape formation step and a shape growth step of the present example. A laser source used (not shown) was a titanium sapphire regenerative amplifier having a wavelength of 800 nm, a pulse width of 130 fs, and a repeating frequency of 1 kHz. A laser beam 31 having a wavelength of 800 nm, a pulse width of 130 fs, a repeating frequency of 1 kHz, a pulse energy of 1.2 mJ, and a beam diameter of 8 mm was obtained from the oscillation source. This laser beam was clipped to a beam diameter of 5 mm via an aperture 32; and divided into two beams by a beam splitter 36 via an attenuator 33, a shutter 34, and a mirror 35. One beam was passed through a shutter 37 and a mirror 38, condensed by a condenser lens 39, and applied to a surface of a workpiece 21 placed on a stage 45. The other beam was passed through an optical path length regulator 40, an ND filter 41, and a mirror 42; and was applied to the surface of the workpiece 21 by a condenser lens 43. Two beam spots at the workpiece surface were configured so as to coincide. The optical path length regulator 40 was composed of two mirrors, which were movable in parallel in an outline arrow direction shown in the drawing, and was adjusted so as to eliminate a difference in optical path length with other beam. The transmittance of the ND filter 41 was selected so that a difference in light intensity between the two beams caused by a difference in the number of mirror sheets after division became equivalent intensity at the surface of the workpiece 21.

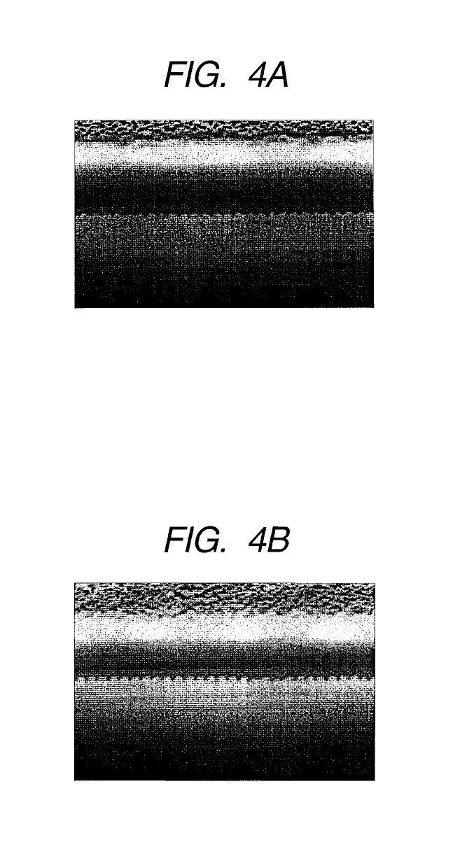

A nickel thin piece was used as the workpiece 21; the condenser lenses 39 and 43 each used a single lens having a focal length of 250 mm; and an intersecting angle between two beams was set to 90 degrees to obtain an interference pattern. With this interference pattern, pattern processing of the basic shape formation step was performed. The irradiation energy was set to 3.5 μJ per 1 beam; and the irradiation time was set to 10 milliseconds. The shutter 37 was always set to an open state and the irradiation time was determined by the shutter 34. With this method, a periodic groove shape having a recess portion of a cycle of approximately 630 nm, a recess portion groove width of approximately 300 nm, and a depth of 200 nm was obtained. FIG. 4A shows an image in which the workpiece 21 was dug by focused ion beam processing and an exposed section was observed obliquely at an angle of 30° by an electron microscope.

The shape growth step was performed to this recess shaped pattern by using the same apparatus. The shutter 37 was always maintained in a close state to perform processing while setting the same conditions as the basic shape formation step. With this method, only one beam was irradiated. The irradiation energy was also set to 3.5 μJ as in the basic shape formation step and irradiation was performed for 30 milliseconds. With this method, the recess portion depth was made to increase to 350 nm while maintaining the pattern shape having the cycle of approximately 630 nm and the recess portion groove width of approximately 300 nm, and an uneven shape having a desirable difference in height was obtained. FIG. 4B shows an image in which the workpiece 21 was dug by focused ion beam processing, and the exposed section was observed obliquely at the angle of 30° by an electron microscope.

In the present example, the basic shape formation step and the shape growth step can be performed by the same processing apparatus. In the case where an interference pattern is formed in the atmosphere to perform processing, it is conceivable that turbulence of an interference pattern is generated due to air turbulence. However, the processing is made to finish in a sufficiently shorter period of time than the cycle of air turbulence; and accordingly, it is possible to avoid its influence. When the processing method of the present example is used, it becomes possible to perform pattern formation utilizing an interference pattern even in the atmosphere, and to obtain a deep uneven shape. Furthermore, the shape growth step is performed to a plurality of basic shape formation spots at the same time, whereby it is also possible to shorten the processing time.

While the present invention has been described with reference to exemplary embodiments, it is to be understood that the invention is not limited to the disclosed exemplary embodiments.

This application claims the benefit of Japanese Patent Applications No. 2008-199489, filed Aug. 1, 2008 and No. 2009-149063, filed Jun. 23, 2009 which are hereby incorporated by reference herein in their entirety.

1. A processing method of processing a recess shape on a surface of a workpiece, comprising:
a basic shape formation step of forming a recess pattern smaller in depth than the recess shape on the surface of the workpiece; and
a shape growth step of irradiating the recess pattern with laser light which has a fluence such that the etching rate at a recess bottom surface of the recess pattern is larger than the etching rate on the workpiece surface and has a beam diameter larger than a width of the recess pattern so as to process the recess shape.

2. The processing method according to 1, wherein the laser light is pulse laser light in which a pulse duration is equal to or more than 10 femtoseconds and less than 1 nanosecond.

3. The processing method according to 1, wherein the fluence of the laser light is equal to or more than 1 time and equal to or less than 40 times as high as a processing threshold of the workpiece.

4. The processing method according to 1, wherein a width of the recess pattern is equal to or more than 0.2 μm and less than 10 μm.
